(19) United States
(12) Patent Application Publication
(10) Pub. No.: US 2021/0081757 A1
(43) Pub. Date: Mar. 18, 2021

(54) PROCESSORS, DEVICES, SYSTEMS, AND METHODS FOR NEUROMORPHIC COMPUTING BASED ON MODULAR MACHINE LEARNING MODELS

(71) Applicant: ALIBABA GROUP HOLDING LIMITED, George Town (KY)

(72) Inventors: Jiaoyan Chen, Hangzhou (CN); Junwen Luo, Sunnyvale, CA (US)

(21) Appl. No.: 16/936,333

(22) Filed: Jul. 22, 2020

(30) Foreign Application Priority Data
Aug. 30, 2019 (CN) 201910816995.1

(51) Int. Cl. G06N 3/04; G06F 17/16; G06F 9/30

(52) U.S. Cl. CPC G06N 3/049; G06F 9/30029; G06F 9/30036; G06F 17/16

(57) ABSTRACT

The present disclosure discloses a method and a computing device for processing an input vector sequence to generate an output vector. The method comprises processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

### CROSS REFERENCE TO RELATED APPLICATION

This disclosure claims the benefits of priority to Chinese application number 201910816995.1, filed Aug. 30, 2019, which is incorporated herein by reference in its entirety.

### BACKGROUND

With the rapid development of machine learning technologies, including deep learning technologies, there have emerged various neural network computing structures, such as convolutional neural networks (CNNs), deep neural networks (DNNs), recurrent neural networks (RNNs) and generative adversarial networks (GANs), the codec, the transformer, and other neural network structures. These results may be used in various technical fields to solve practical problems. For example, in the fields of video surveillance or medical treatment, computing structures based on the CNNs of deep learning may be used for image processing. In the field of natural language processing, codecs may be used for speech processing such as natural language understanding, translation, and generation.

### SUMMARY OF THE DISCLOSURE

According to some embodiments of the present disclosure, a method for processing an input vector sequence to generate an output vector is provided. The method comprises processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

According to some embodiments of the present disclosure, a computing device configured to processing an input vector sequence to generate an output vector is provided. The computing device comprises one or more processors; and memory coupled to the one or more processors and storing instructions that, when executed by the computing device, cause the computing device to perform: processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

According to some embodiments of the present disclosure, a processor configured to process an input vector sequence to generate an output vector is provided. The processor comprises one or more processing cores, wherein each processing core is configured to execute instructions stored on memory to perform: processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

According to some embodiments of the present disclosure, a system-on-chip including a processor configured to process an input vector sequence to generate an output vector is provided. The processor comprises one or more processing cores. Each processing core is configured to execute instructions stored on memory to perform processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

According to some embodiments of the present disclosure, a smart device configured to process an input vector sequence to generate an output vector is provided. The smart device comprises one or more processors; and memory coupled to the one or more processors and storing instructions that, when executed by the computing device, cause the computing device to perform: processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating the output vector based on the sub-vector sequence.

According to some embodiments of the present disclosure, a non-transitory computer-readable medium storing program instructions, that when read and executed by a processor, cause the processor to perform processing one or more input vectors of an input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and after sequentially generating the one or more corresponding sub-vectors for the one or more input vectors in the input vector sequence to form a sub-vector sequence including the one or more sub-vectors, generating an output vector based on the sub-vector sequence.

### BRIEF DESCRIPTION OF THE DRAWINGS

In order to achieve the above and related objectives, the following description and accompanying drawings are used to describe certain illustrative aspects, which indicate various ways in which the principles disclosed herein may be practiced, and all aspects and their equivalents are intended to fall within the scope of the claimed subject matter. The above and other objectives, features, and advantages of the present disclosure will become more apparent by reading the following detailed description in conjunction with the accompanying drawings. Throughout this disclosure, the same reference labels generally refer to the same components or elements.

FIG. 1 shows a schematic diagram of a computing unit according to some embodiments of the present disclosure.

FIG. 2 shows a schematic diagram of a sub-vector generator in a computing unit according to some embodiments of the present disclosure.

FIG. 3 shows a schematic diagram of a recurrent neural network (RNN) adopted in a sub-vector generator according to some embodiments of the present disclosure.

FIG. 4 shows a schematic diagram of a compression processing method adopted in a sub-vector generator according to some embodiments of the present disclosure.

FIG. 5 shows a schematic diagram of a computing unit according to some embodiments of the present disclosure.

FIG. 6 shows a schematic diagram of a computing unit according to some embodiments of the present disclosure.

FIG. 7 shows a schematic diagram of a processor according to some embodiments of the present disclosure.

FIG. 8 shows a schematic diagram of a processor according to some embodiments of the present disclosure.

FIG. 9 shows a schematic flowchart of a computing method according to some embodiments of the present disclosure.

FIG. 10 shows a block diagram of a computing method according to some embodiments of the present disclosure.

FIG. 11 shows a block diagram of a computing method according to some embodiments of the present disclosure.

FIG. 12 shows a block diagram of a system-on-chip according to some embodiments of the present disclosure.

### DETAILED DESCRIPTION

Hereinafter, example embodiments of the present disclosure will be described in more detail with reference to the accompanying drawings. Although example embodiments of the present disclosure are shown in the accompanying drawings, it should be understood that the present disclosure can be implemented in various forms and should not be limited by the embodiments set forth herein. Rather, these embodiments are provided to enable a more thorough understanding of the present disclosure and to fully convey the scope of the present disclosure to those skilled in the art.

Deep learning technologies may use a huge network structure with many parameters to learn through a training process. Sometimes there may have problems such as the amount of training data is large, and the training time is long. When the deep learning technologies are applied to the space-time computing field, for example, in real-time multi-mode application scenarios such as motion detection, speech recognition, or automatic navigation, a huge amount of computation may be required. Accordingly, specially designed computing chips may be used to run neural network algorithms to solve the problem of computing overhead.

Spiking neural networks (SNNs) have been applied in the neuromorphic computing technologies and have advantages in processing sequential inputs with successive relationships, for example, in the space-time field. However, problems exist in some neuromorphic computing technologies regarding how to perform fast learning and training, with high scalability and reduced computation. They also do not provide more general and complete solutions to deal with problems in the space-time field.

In some embodiments according to the present disclosure, a vector is provided for processing, and the vector may correspond to features of an object to be processed. Each computing unit processes an input vector to generate an output vector, and the input and output vectors have substantially the same structure or dimension, so that an input vector to be processed by one computing unit may be an output vector of another computing unit. Accordingly, by providing the input vector and output vector to be processed by each computing unit, and planning connection relationships between these computing units, neuromorphic computing can be modularly designed, which can then be applied to various complex computing scenarios so as to process sequential data with a dimension of time.

In some embodiments according to the present disclosure, each computing unit obtains a sub-vector by compressing an output calculated by a reservoir computing method, and then combines sub-vectors to obtain an output sequence. Accordingly, the output sequence has a small size, so that it can be quickly transmitted between computing units, reducing the delay caused by network transmission.

In some embodiments according to the present disclosure, a vector table is used by the computing unit to store the association between computed output vectors and sub-vectors, and even between output vectors, sub-vectors, and predicted next input vectors. The vector table can be used to control operations of the computing unit so that the computing unit can be flexibly applied to application scenarios such as inference or cognition.

In some embodiments according to the present disclosure, the definition of invariant representation is provided to represent multiple similar input vectors for subsequent processing, thereby reducing the impact of subtle changes of input vectors on output vectors and rendering the solution more focused on the structure and repetitive pattern of space-time sequences.

In some embodiments according to the present disclosure, in a recurrent neural network (RNN) used for reservoir computing, parameters of intermediate layers may not be trained. Even parameters of input layers and output layers may not be trained, thereby solving the problem of failing to perform a fast machine learning process due to a prolonged training.

It is appreciated that vectors are provided for illustrative purpose in the present disclosure, and they are not intended to be limiting. Any other suitable form, such as a concept, an object, a feature, a variable, a value, or a function, etc., can be processed by a similar processor, device, or system, using a similar method as described herein, and is within the scope of the present disclosure.

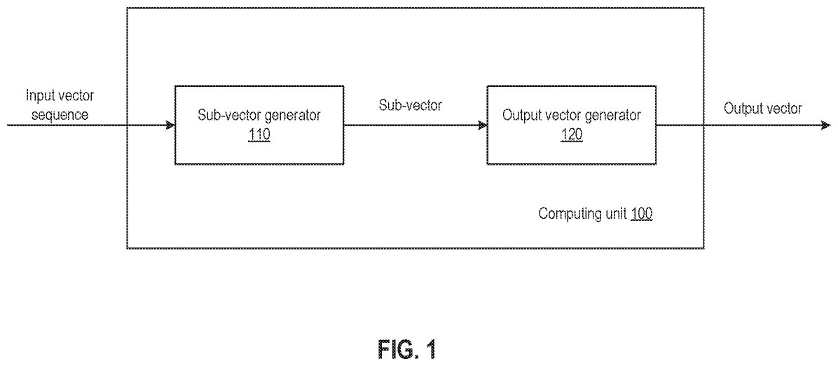

FIG. 1 shows a schematic diagram of a computing unit 100 according to some embodiments of the present disclosure. In some embodiments, computing unit 100 may process an input vector sequence to generate an output vector. In some embodiments, a vector provided in the present disclosure may be used to characterize features of a target object to be processed. In some embodiments, the input vector sequence may include a plurality of input vectors. In some embodiments, the vector can be a feature vector of a target object. In some embodiments, various methods may be used for converting features of a target object into feature vectors. For example, when the target object includes a segment of audio, the segment of audio may be divided into multiple sub-segments. The sound intensity of each sub-segment of audio may be acquired as a feature value. The feature values of the multiple sub-segments may be combined to form a feature vector representing the sound intensity of this segment of audio. It is appreciated that the present disclosure is not limited to a specific method of generating feature vectors, and all approaches of generating feature vectors according to features of a target object are within the scope of the present disclosure.

In some embodiments, vectors may have different levels. For example, higher-level vectors can be generated based on lower-level vectors. In some embodiments, for a piece of text, a vector corresponding to one sentence may be a high-level vector, a vector corresponding to one word may be a low-level vector, and a vector corresponding to one letter may be a lower-level vector. In some embodiments, for a human body motion, a vector corresponding to the motion status of the entire human body may be a high-level vector, a vector corresponding to the motion status of a respective part of the human body may be a low-level vector, and a vector corresponding to one certain type of motion of a respective human body part may be a lower-level vector.

In some embodiments as shown in FIG. 1, computing unit 100 may receive an input vector sequence and process this input vector sequence to generate an output vector. The output vector may be a high-level vector, while the input vector may be a low-level vector. In some embodiments, the input vector sequence may include multiple input vectors. These input vectors may be arranged in a sequence, where there may be an association relationship between an input vector and another input vector in front of the input vector in the sequence. In some embodiments, the input vectors may be related in time. For example, in an input vector sequence, an input vector may be generated at a time point associated with a timestamp or generate in a period of time, and a next input vector may be generated at a subsequent time point associated with a next timestamp or generated in a subsequent period of time.

In some embodiments, two input vector sequences may be separated by a punctuation mark, such as an interpunct or a middle dot “•”, as shown in an example below:
{interpunct, Input Vector 1, Input Vector 2, Input Vector 3, interpunct, Input Vector 4, Input Vector 5, Input Vector 6, interpunct},
   where input vectors 1-3 constitute a first input vector sequence, and input vectors 4-6 constitute a second input vector sequence. Computing unit 100 may process the first input vector sequence and the second input vector sequence to generate output vector 1 and output vector 2 respectively. The generated output vectors may be separated by a punctuation mark, such as a interpunct or a middle dot “•”, to produce an output vector sequence, such as:
{Interpunct, Input vector 1, Output vector 2, Interpunct}.

In some embodiments, one or more output vectors of computing unit 100 may be used as an input vector sequence for another computing unit 100, which can be suitable for processing vectors in a hierarchical manner.

In some embodiments, as shown in FIG. 1, computing unit 100 may include a sub-vector generator 110 and output vector generator 120. Sub-vector generator 110 may receive an input vector sequence and performs computation for each input vector in the input vector sequence. For example, computation may be performed on one or more input vectors adjacent to a respective input vector in the input vector sequence based on a computing approach of machine learning to generate a sub-vector. In some embodiments, when the input vector is a vector, the generated sub-vector may also be a vector and has substantially similar size as that of the input vector.

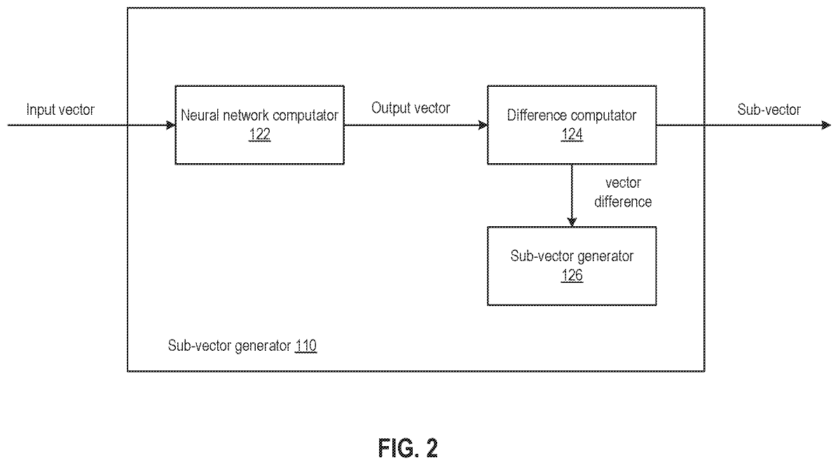

FIG. 2 shows a schematic diagram of sub-vector generator 110 of computing unit 100 of FIG. 1, according to some embodiments of the present disclosure. In some embodiments, as shown in FIG. 2, sub-vector generator 110 may include a neural network computator 122, a difference computator 124, and sub-vector generator 126. In some embodiments, when the input vector sequence is a vector sequence having a successive association relationship, such as a vector sequence having a temporal relationship, neural network computator 122 may adopt a reservoir computing method to process the input vectors. In some embodiments, computator 122 may process the adjacent input vectors of a respective input vector in the input vector sequence using a recurrent neural network (RNN) to obtain a current output vector of the RNN.

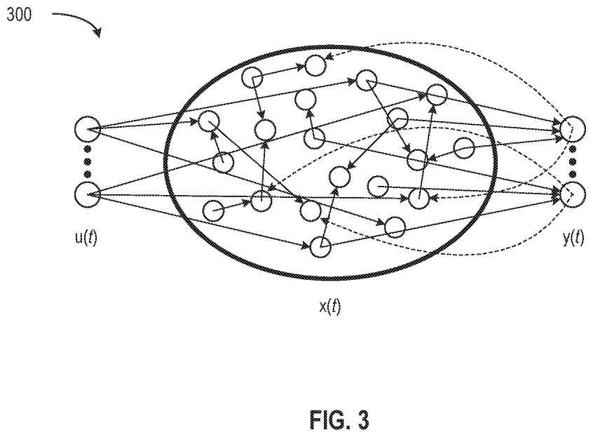

FIG. 3 shows an example diagram of RNN 300 adopted in neural network computator 122 according to some embodiments of the present disclosure. In some embodiments, as shown in FIG. 3, an input layer of RNN 300 is u(t), an intermediate layer is x(t), and an output layer is y(t). In RNN 300, the intermediate layer may be calculated as follows:

x(t+1)=(1−a)x(t)+a AF(U(u(t+1),x(t),y(t),Θ)+b)

where a is an influence factor with a value between 0 and 1, reflecting the influence of a historical value x(t) on a current value x(t+1). AF is an activation function. In some embodiments, the activation function may adopt a spiking neural model function, and use Θ as a threshold of the activation function. b is noise introduced for increasing the stability of the operation. Further,

U(u(t+1),x(t),y(t))=Wᵢₙu(t+1)+Wx(t)+W_{fb}y(t)+v

where Wₘ, W, W_{fb} represent weights of the input layer, the intermediate layer, and the output layer respectively, and v is a constant bias.

In some embodiments of the present disclosure, after determining various parameters in the RNN, such as a, b, Θ, Wᵢₙ, W, W_{fb}, the value of the intermediate layer x(t+1) can be calculated by using the current input vector as the input layer u(t+1), and taking the values of the historical intermediate layer x(t) and the output layer y(t) into consideration. The value of y(t+1) may also be calculated according to the relationship between the output layer and the intermediate layer.

Referring to FIG. 2, difference computator 124 may acquire the current output y(t+1) calculated by neural network computator 122 and the previous output y(t), and calculate a difference between the two to obtain a vector difference (e.g., a difference between two vectors). In some embodiments, a logic operation of exclusive or (XOR) may be performed to the current output vector y(t+1) and the previous output vector y(t) to generate the vector difference, such as:

Vector Difference=y(t)XORy(t+1).

Sub-vector generator 126 may compress the vector difference generated by difference computator 124 to generate a sub-vector. In some embodiments, the vector size of the output y(t) generated by RNN 300 may be different from the size of the input vector, when taken the structure of the neural network into consideration. In some embodiments, the vector size of the output y(t) may even be much larger than the size of the input vector. Accordingly, it may be necessary to compress the vector size of the output y to obtain the same size as that of the input vector.

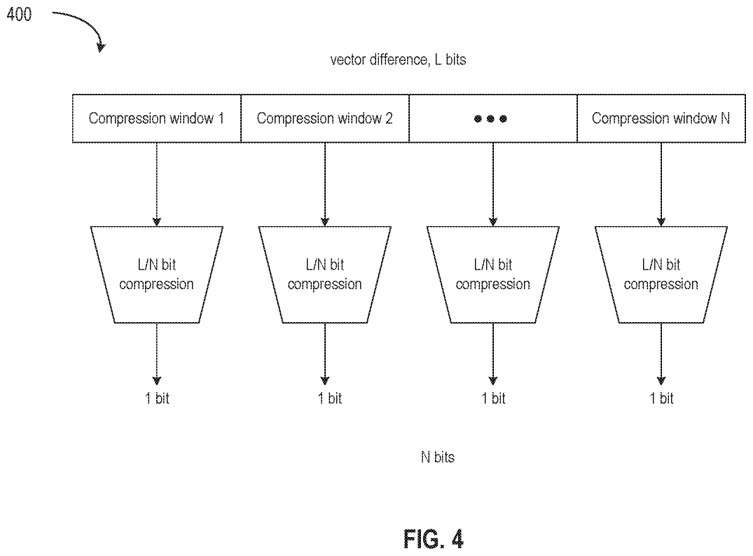

FIG. 4 shows a schematic diagram of a compression processing method 400 performed by sub-vector generator 126 according to some embodiments of the present disclosure. In some embodiments as shown in FIG. 4, a vector difference calculated by difference computator 124 may be first divided into a predetermined number of compression windows. In some embodiments, assuming that a size of the vector difference is L bits, and a size of a sub-vector is N bits, then a number of L/N of compression windows may be set. In some embodiments, L/N bits of the vector difference occupied in each compression window may be compressed to 1 bit with a value of 1 or 0 according to a compression function and the values of the L/N bits. The bit values output by all the compression windows may then be combined to form a sub-vector with a length of N bits. In some embodiments, the L/N bits occupied by each compression window can be compressed to 1 bit using the following steps:

first, calculating an average value AVG_window of each compression window;

then, calculating the maximum value MAX_total of all AVG_window values; and

for each compression window, if AVG_window=MAX_total, outputting a value of 1, otherwise, outputting a value of 0.

It is appreciated that the present disclosure is not limited to the process of compressing the value in each compression window to 1 bit as described herein. Any suitable methods that can perform compression from L/N bits to 1 bit are within the scope of the present disclosure.

It is also appreciated that the present disclosure is not limited to the process for compressing L bits to N bits as described herein. Any suitable methods that can compress L bits to N bits are within the scope of the present disclosure.

Returning to FIG. 1, in some embodiments, after sub-vector generator 110 generates a sub-vector for each input vector of the input vector sequence, output vector generator 120 may generate an output vector based on a sub-vector sequence including sub-vectors generated for the input vectors respectively.

In some embodiments, the output vector may be constructed based on all sub-vectors in the sub-vector sequence. According some embodiments of the present disclosure, bit-level logic operation may be performed to all sub-vectors to generate an output vector. For example, the output vector can be obtained according to the following operation:

SC(1)XORSC(2)XOR . . . XORSC(N)

where SC (1), SC (2), . . . , SC (N) are sub-vectors corresponding to input vector 1, input vector 2, . . . , input vector N, respectively.

In some embodiments, the advantage of using bit-level logic operation of exclusive or (XOR) includes that it may be possible to reverse code each sub-vector from an output vector. It is appreciated that the present disclosure is not limited to the logic operation described herein. Other bit-level logic operations may also be applied, including but not limited to an XNOR (Exclusive NOR) operation.

As described above, for each input vector sequence, computing unit 100 generates a corresponding output vector, and the output vector has the same size as the input vector, thereby facilitating transmission between the computing units. Further, the output vector may be used as an input vector of another computing unit 100, 500, or 600.

According to some embodiments of the present disclosure, computing unit 100 may continuously receive multiple input vector sequences, and generate an output vector for each input vector sequence, thereby constructing one or more output vector sequences for the multiple input vector sequences. In some embodiments, the output vector sequence may carry higher-level vectors extracted from lower-level vectors represented by the input vector sequences. The output vector sequence may be used as an input vector sequence of a next-level computing unit 100 to extract higher-level vectors. The embodiments described in the present disclosure may effectively reduce the amount of data transmission between computing units 100, so as to achieve hierarchically distributed and parallel neuromorphic computation.

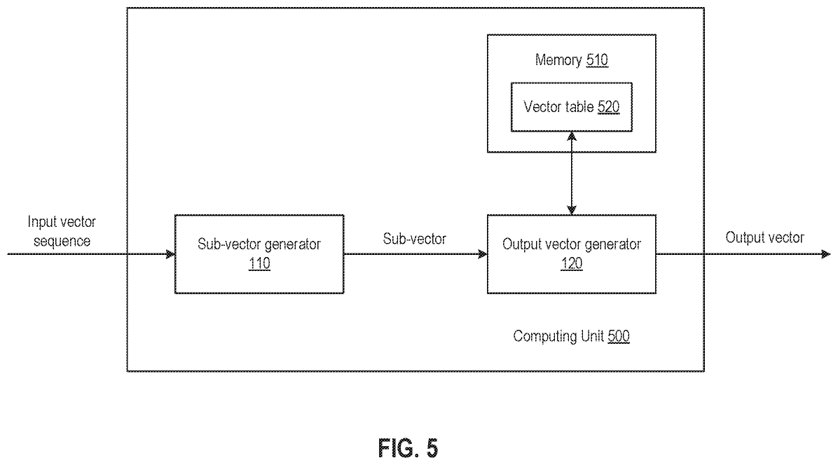

FIG. 5 shows a schematic diagram of computing unit 500 according to some embodiments of the present disclosure. In some embodiments, computing unit 500 shown in FIG. 5 may be a further extension of computing unit 100 of FIG. 1. It is appreciated that identical reference numbers and blocks may be used to indicate the same or corresponding components in respective devices.

In some embodiments as shown in FIG. 5, computing unit 500 may further include a memory 510 storing a vector table 520. Sub-vector generator 110 and output vector generator 120 may respectively control the sub-vector generation process and output vector generation process according to the content stored in vector table 520. Accordingly, the function of an inhibition function used by the computing unit (e.g., computing unit 500) in an inference scenario may be achieved. In some embodiments, an inhibition function may be used to inhibit sub-vector computation when no matching result can be found in association table (e.g., vector table 520) at the corresponding timestamp as described herein. The function of a prediction function (e.g., a predictive function) for speeding up the sub-vector generation processing may also be achieved. In some embodiments, a prediction function may be carried out via a look-up-table operation. For example, as described herein, a sub-vector may be used as a key to load preserved input vector. The loaded result may be validated against actual input vector to determine whether the prediction is effective.

According to some embodiments, in order to implement the inhibition function, one or more (e.g., sometimes multiple) reserved output vectors are stored in vector table 520. In some embodiments, after generating an output vector (also referred to as an output vector candidate), output vector generator 120 may compare the generated output vector candidate with the one or more reserved output vectors. In some embodiments, when the generated output vector candidate is different from any one of the reserved output vector(s), the output probability candidate may be invalidated. For example, no output vector may be outputted. In another example, the output vector may be outputted as a vector of all zeros. Further, sub-vector generator 110 may be instructed not to generate any sub-vectors. In some embodiments, when the generated output vector candidate is included in the reserved output vector(s), this output vector candidate may be outputted. Further, sub-vector generator 110 may be instructed to continue with the operation of generating sub-vectors. In some embodiments, vector table 520 may be used to describe predetermined categories of output probabilities that can be output from computing unit 500. That is, computing unit 500 may output one or more reserved output vectors only. Accordingly, when computing unit 500 is used in an inference mode, only one or more predetermined inference results may be generated.

According to some embodiments for implementing the inhibition function, vector table 520 may store reserved output vector(s) and a plurality of reserved sub-vectors corresponding to the reserved output vectors. In some embodiments, each reserved sub-vector may correspond to a specific sequence position. In some embodiments, when the input vector sequence is a time-dependent sequence, each reserved sub-vector may correspond to a specific timestamp position. For example, vector table 520 may have the following structure:

TABLE 1

| Output Vectors (OC) | Sub-vectors (SC) | Timestamps |
|---|---|---|
| OC1 | SC-1-1 | T-1 |
| | SC-1-2 | T-2 |
| | . . . | . . . |
| | SC-1-N | T-N |
| . . . | . . . | . . . |
| OC2 | SC-2-1 | T-1 |
| | SC-2-2 | T-2 |
| | . . . | . . . |
| | SC-2-N | T-N |

In some embodiments, after generating a sub-vector (also referred to as a sub-vector candidate), sub-vector generator 110 may compare the sub-vector, according to a sequence position corresponding to the sub-vector, with a reserved sub-vector at a corresponding position stored in vector table 520. For example, if sub-vector generator 110 currently generates a SC-candidate at timestamp T-2, this SC-candidate may be compared with sub-vectors SC-1-2 and SC-2-2 at the same timestamp T-2 in vector table 520. When the sub-vector candidate is different from any one of the reserved sub-vectors at the same sequence position, sub-vector generator 110 may no longer generates sub-vectors, and may instruct output vector generator 120 to invalidate the output vector. For example, output vector generator 120 may not output the output vector, or output the output vector as a vector of all zeros. When the sub-vector candidate is the same as one of the reserved sub-vectors, sub-vector generator 110 may continue with the processing, e.g., generating sub-vectors. In some embodiments, sub-vector generator 110 may only generate predetermined sub-vectors. Accordingly, output vector generator 120 may only generate predetermined output vectors. As a result, the system and method as described herein may be applied to an inference mode with a finer granularity.

According to some embodiments, in order to realize the function of a prediction function, in addition to storing the above-mentioned reserved output vectors and multiple reserved sub-vectors corresponding to the reserved output vectors, vector table 520 may further store a next input vector corresponding to each sub-vector. In some embodiments as described above, computing unit 500 may generate a sub-vector for each input vector of the input vector sequence, and then generate an output vector based on the sub-vector sequence. In some embodiments, because there is a successive association among input vectors, the sub-vector sequence is likely to be the same for the same output vectors. Accordingly, after a sub-vector is generated according to a current vector, the content of a next input vector can be expected.

In some embodiments, vector table 520 may have the following structure:

TABLE 2

| Output | Sub- | Next Input | |
|---|---|---|---|
| Vectors (OC) | vectors (SC) | Vectors (NC) | Timestamps |
| OC1 | SC-1-1 | NC-1-1 | T-1 |
| | SC-1-2 | NC-1-2 | T-2 |
| | . . . | . . . | . . . |
| | SC-1-N | NC-1-N | T-N |
| . . . | . . . | . . . | . . . |
| OC2 | SC-2-1 | NC-2-1 | T-1 |
| | SC-2-2 | NC-2-2 | T-2 |
| | . . . | . . . | . . . |
| | SC-2-N | NC-2-N | T-N |

In some embodiments, when a prediction function is used, upon receiving an input vector (IC) with a certain timestamp, sub-vector generator 110 may first look up vector table 520 for a reserved input vector (from column NC) with an associated timestamp, for example, a timestamp prior to the certain timestamp of the received input vector (IC). Sub-vector generator 110 may compare the received input vector (IC) with the reserved input vector (NC) identified in vector table 520. When the two are the same, a predictive function including a prediction loop may be activated. At this moment, sub-vector generator 110 may not generate sub-vector. Instead, sub-vector generator 110 may look up vector table 520 for a sub-vector (SC) with the same timestamp of the received input vector (IC) as the sub-vector to be output. Sub-vector generator 110 may then obtain the value of a next input vector (NC) with the same timestamp of the received input vector (IC). In some embodiments, the value of this next input vector (IC) may be compared with a next input vector in the input vector sequence to be processed by sub-vector generator 110. When the two are consistent, the prediction loop may continue. When the two are not consistent, the prediction loop is ended, and sub-vector generator 110 may be caused to perform the normal sub-vector generation process. A warning that the input vector violates the expected input vector may also be triggered.

For example, when sub-vector generator 110 receives input vector IC with a timestamp T-2, it may compare input vector IC with next input vector(s) (such as NC-1-1, NC-2-1) at timestamp T-1 (e.g., prior to T-2) in vector table 520. When these are identical input vectors (for example, NC-2-1 is an identical hit for the received IC), the prediction loop may be determined to effective. Accordingly, SC-2-2 (at T-2) may be used directly as sub-vector SC to be output by sub-vector generator 110 without performing complicated calculation. In addition, next input vector NC-2-2 (at T-2) corresponding to SC-2-2 is acquired. NC-2-2 may be compared with an input vector at timestamp T-3 in the input vector sequence processed by sub-vector generator 110. When the two values are consistent, the prediction loop is continued.

When the two values are inconsistent, or a corresponding next input vector has not been found before (e.g., NC with timestamp T-1 is different from the received input vector IC), the prediction loop is terminated or exited. In addition, sub-vector generator 110 may be caused to perform the normal sub-vector generation process. According to some embodiments, when exiting the prediction loop, a warning may be issued regarding that the input vector (IC) is not among the predetermined or predicted input vectors. This may be suitable in a field where computing unit 500 is used for surveillance. For example, when an input vector (e.g., an object feature) that is not predetermined in advance or is unpredicted appears, a warning that an abnormal condition is identified can be triggered.

In some embodiments, computing unit 500 as shown in FIG. 5 includes vector table 520 that stores the relationship between output vectors calculated by computing unit 500 and sub-vectors, and input vectors. When vector table 520 has a large size, it may store most of the input vectors and sub-vectors that can be processed by computing unit 500. As such, when the function of a prediction function is activated in computing unit 500, the computing needs for calculating sub-vector by sub-vector generator 110 can be significantly reduced. In some embodiments, when the function of an inhibition function is activated in computing unit 500, results of various prediction branches (corresponding to certain predetermined output vectors) required by an inference scenario may be completely obtained.

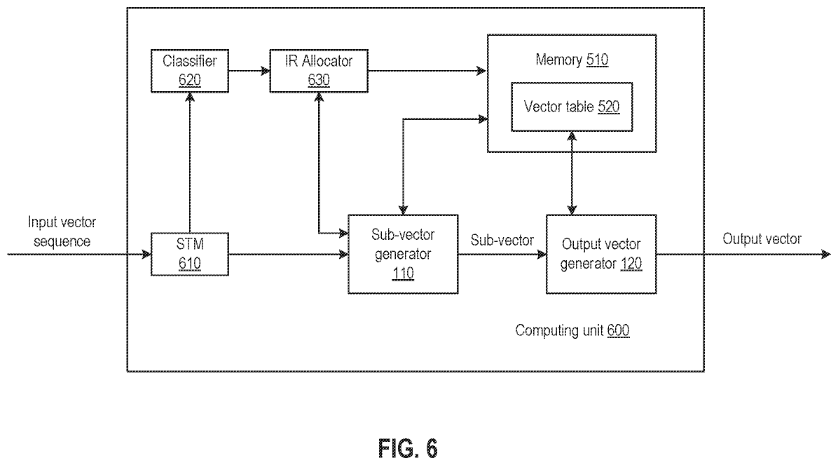

FIG. 6 shows a schematic diagram of a computing unit 600 according to some embodiments of the present disclosure. It is appreciated that computing unit 600 shown in FIG. 6 may be a further extension of computing unit 100 shown in FIG. 1 or computing unit 500 shown in FIG. 5. Identical reference numbers or blocks may be used to indicate the same or corresponding components.

As shown in FIG. 6, computing unit 600 may include a short-term memory (STM) 610, a classifier 620, and an invariant representation (IR) allocator 630. In some embodiments, before sub-vector generator 110 processes input vectors, computing unit 600 may store the received input vector sequence in STM 610. STM 610 may cache multiple input vectors of the input vector sequence. In some embodiments, the cached input vector sequence may be cleared from STM 610 after a period of time or after the processing of the input vector sequence is completed.

In some embodiments, classifier 620 can classify the input vectors cached in STM 610. According to some embodiments, classifier 620 may calculate similarities between some or all the cached input vectors, and classify similar input vectors into one category. There may have various methods for calculating the similarities between the input vectors. For example, similarities between the input vectors can be calculated using Hamming distance, overlap similarity, Euclidean distance, Pearson similarity, cosine similarity, and Jaccard similarity, etc.

In some embodiments, invariant representation (IR) allocator 630 may allocate pre-stored invariant representations to the categories of input vectors respectively, for example, one pre-stored invariant representation for each category. In some embodiments, an invariant representation may be a vector of the same size as that of the corresponding input vector. In some embodiments, a predetermined number of invariant representations may be stored in computing unit 600 in advance.

According to some embodiments, classifier 620 can read the input vectors cached in STM 610 one by one, and calculate a similarity between a received input vector and one of the input vectors that have been processed. When it is determined based on the calculation that there is a input vector that has been processed similar to the receive input vector, allocator 630 may allocate, to this received input vector, the invariant representation previously allocated to the similar input vector that has been processed. When it is determined that there is no similar input vector from the processed input vectors, allocator 630 may allocate an unused invariant representation to this received input vector.

In some embodiments, classifier 620 and allocator 630 can perform the allocation of invariant representations to input vectors on an input-sequence basis, before example, as shown below:

TABLE 3

| | | | Invariant |
|---|---|---|---|
| Sequences | Temporal Orders | Input Vectors | Representations |
| 1 | 1 | A | IR1 |
| | 2 | B | IR2 |
| | 3 | C | IR3 |
| | 4 | D | IR4 |
| | 5 | A | IR1 |
| | 6 | B | IR2 |
| | 7 | C | IR3 |
| | 8 | D | IR4 |
| 2 | 1 | E | IR1 |
| | 2 | E | IR1 |
| | 3 | F | IR2 |
| | 4 | F | IR2 |
| | 5 | G | IR3 |
| | 6 | G | IR3 |
| | 7 | H | IR4 |
| | 8 | H | IR4 |

In some embodiments as described herein, STM 610, classifier 620, and allocator 630, working collectively, may allocate the same invariant representation to the same or similar input vectors in each input sequence. As such, subsequently, sub-vector generator 110 and output vector generator 120 may directly process invariant representations, instead of input vectors. Accordingly, computing unit 600 can be more focused on the structure and repetitive pattern of an input sequence.

In addition, the number of invariant representations may be limited. If computing unit 600 is a further extension of computing unit 500, by using invariant representations in place of input vectors in vector table 520 (for example, in the above Table 2), index of invariant representation can be used instead of invariant representations by themselves, thus further reducing the size of vector table 520.

Computing units and various components in the computing units have been described above with reference to FIGS. 1-6. It is appreciated that the division of the various components in computing units (e.g., 100, 500, and 600) described above is a logical division. The computing unit can be implemented in any suitable hardware, such as a processing core, a processing chip, or a processor, etc.

As described above with reference to FIGS. 1-6, the computing unit processes an input vector sequence to generate an output vector. The output of such computing unit can be used as an input for another computing unit. With such a modular design of a computing unit, multiple computing units can be combined to work collectively for solving complex problems having space-time associations, such as a conversation system, automatic navigation, video surveillance, etc.

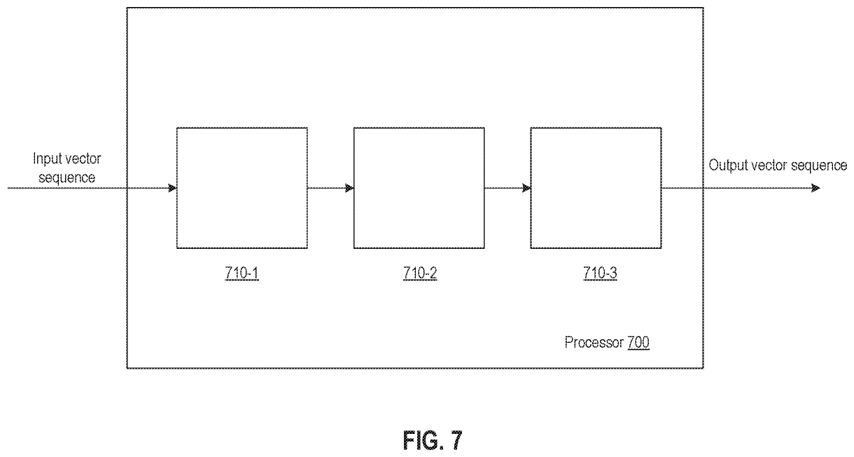

FIG. 7 shows a schematic diagram of processor 700 according to an embodiment of the present disclosure. As shown in FIG. 7, processor 700 includes a plurality of processing cores 710-1, 710-2, and 710-3, or more (not shown). Each processing core can implement some or all the functions of computing units 100, 500, and 600 described above with reference to FIGS. 1-6. For example, processing core 710-1 may receive an input vector sequence for processing to generate an output sequence. Processing core 710-2 may be coupled to processing core 710-1, receive the output sequence from processing core 710-1 as an input sequence for processing, and generate an output sequence by processing core 710-2. Processing core 710-3 may be coupled to processing core 710-2, receive the output sequence of processing core 710-2 as an input sequence, and generate an output sequence as a final output of processor 700.

In some embodiments, processor 700 shown in FIG. 7 has a plurality of processing cores 710-1 to 710-3 connected in sequence, wherein each processing core sequentially processes lower-level vectors (e.g., received from a previous processing core in sequence) and generates higher-level vectors (e.g., as input for a subsequent processing core in sequence). Processor 700 may output the highest-level vector as the final output. It is appreciated that the plurality of processing cores may also be connected in other suitable method.

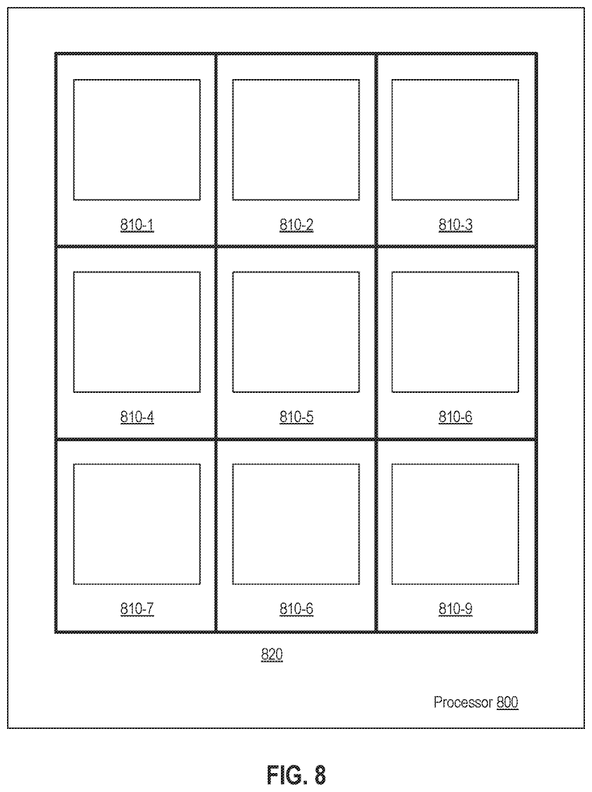

FIG. 8 shows a schematic diagram of processor 800 according to some embodiments of the present disclosure. As shown in FIG. 8, processor 800 includes multiple processing cores 810. For example, FIG. 8 shows nine processing cores, 810-1 to 810-9. In some embodiments, the multiple processing cores may be connected to system bus 820 provided by processor 800. As such, the connection relationship between these processing cores 810 may be defined by system bus 820. In some embodiments, an output vector of a processing core 810 may be provided to multiple processing cores as an input vector. In some embodiments, output vectors of one or more processing cores may be simultaneously provided to one processing core as an input vector. As such, complex and modular neuromorphic computation can be realized.

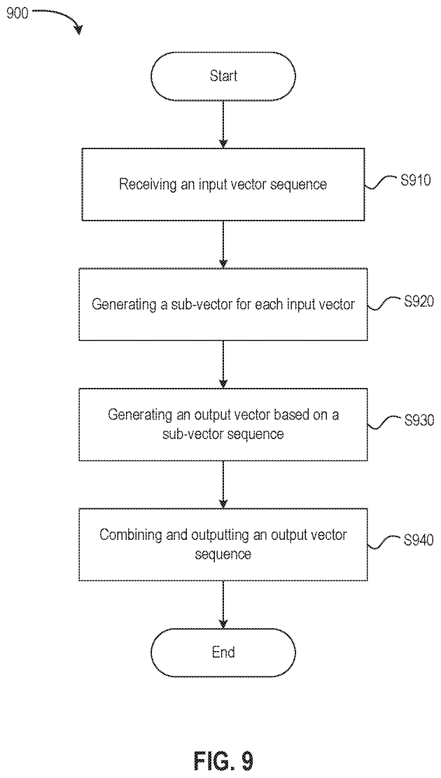

FIG. 9 shows a block diagram of a method 900 according to some embodiments of the present disclosure. In some embodiments, method 900 shown in FIG. 9 may be implemented by the computing units described above with reference to FIGS. 1-6. For the sake of brevity, parts similar to the structures and implement similar processing by the corresponding components in the computing units may not be repeated.

As shown in FIG. 9, in step S910, an input vector sequence is received. According to some embodiments, the input vector sequence may be separated by a punctuation mark, such as a interpunct or a middle dot “•”, as shown as an example below:
{Interpunct, Input Vector 1, Input Vector 2, Input Vector 3, Interpunct, Input Vector 4, Input Vector 5, Input Vector 6, Interpunct}
   where input vectors 1-3 constitute a first input vector sequence, and input vectors 4-6 constitute a second input vector sequence. Method 900 may process the first input vector sequence and the second input vector sequence, e.g., one by one, to generate output vector 1 and output vector 2.

Next, in step S920, for each input vector in each input vector sequence, adjacent input vectors may be processed based on machine learning computation to generate sub-vectors for input vectors of the input vector sequence, e.g., one sub-vector for each input vector.

In order to generate sub-vectors, a reservoir computing method may be used to process the input vectors when considering that the input vector sequence is a vector sequence with a successive association, such as a temporal successive association. In some embodiments, in step S920, firstly, a recurrent neural network (RNN) may be used to process the adjacent input vectors to obtain a current output vector of the RNN. Examples of the structure of the RNN are described above with reference to FIG. 3 and will not be repeated here.

Further, in step S920, current output y(t+1) calculated by the RNN and previous output y(t) can be obtained. A difference between current output and the previous output may be calculated to obtain a vector difference. According to some embodiments, an XOR calculation may be performed to the current output vector y(t+1) and previous output vector y(t) to generate the vector difference, such as:

vector difference=y(t)XORy(t+1).

Next, still in step S920, the vector difference may be compressed to generate a sub-vector. In some embodiments, the vector size of the output y(t) generated by RNN 300 may be different from the size of an input vector, when considering the structure of the neural network. In some embodiments, the vector size of the output y(t) may even be much larger than the size of an input vector. Accordingly, it may be necessary to compress the vector size of output y to obtain the same size as that of an input vector. Some exemplary embodiments of the compression processing are described above with reference to FIG. 4 and will not be repeated here. It is appreciated that the present disclosure is not limited to the processing methods of compressing L bits (e.g., the size of an output vector of the RNN) to N bits (the vector size of an output vector) as described herein as examples. Any other suitable methods that can compress L bits to N bits fall within the scope of the present disclosure.

After sequentially generating sub-vectors for the input vectors of the input vector sequence in step S920, e.g., a sub-vector generated for a corresponding input vector in the input vector sequence, in step S930, an output vector may be generated based on a sub-vector sequence comprised of the sub-vectors generated in step S920.

In some embodiments, the output vector may be constructed based on some or all sub-vectors in the sub-vector sequence. According to some embodiment of the present disclosure, it is possible to perform a bit-level logic operation on some or all sub-vectors to generate an output vector. For example, the output vector can be obtained according to the following operation:

SC(1)XORSC(2)XOR . . . XORSC(N)

where SC (1), SC (2), . . . , SC (N) are sub-vectors corresponding to input vector 1, input vector 2, . . . , input vector N, respectively.

It is appreciated that the present disclosure is not limited to the XOR bit-level logic operation, and may further adopt other bit-level logic calculations, such as an XNOR (Exclusive NOR) operation, etc.

Accordingly, in step S930, vector corresponding output vector can be generated for each input vector sequence. The output vector may have the same size as the input vector, thereby facilitating transmission between the computing units and further serving as an input vector of another computing unit 100, 500, or 600.

In some embodiments, when multiple input vector sequences are received in step S910, as described above, after generating output vectors for the multiple input vector sequences respectively in step S930, e.g., an output vector generated for a corresponding input vector sequence, an output vector sequence can be constructed based thereon and output in step S940. According to some embodiments of the present disclosure, when the output vectors generated in step S930 are output vector 1 and output vector 2, respectively, in step S940, the generated output vectors can be separated by a punctuation mark, such as a interpunct or a middle dot “•”, to generate an output vector sequence, such as:
{Interpunct, Input vector 1, Output vector 2, Interpunct}.

In some embodiments, the output vector sequence may carry higher-level vectors extracted from lower-level vectors represented by the input vector sequences. Further, the output vector sequence may be used as an input vector sequence of a next-level when performing method 900 so as to extract higher-level vectors. The embodiments described in the present disclosure may effectively reduce the amount of data transmitted between different computing units performing method 900, so as to achieve hierarchically distributed and parallel neuromorphic computation.

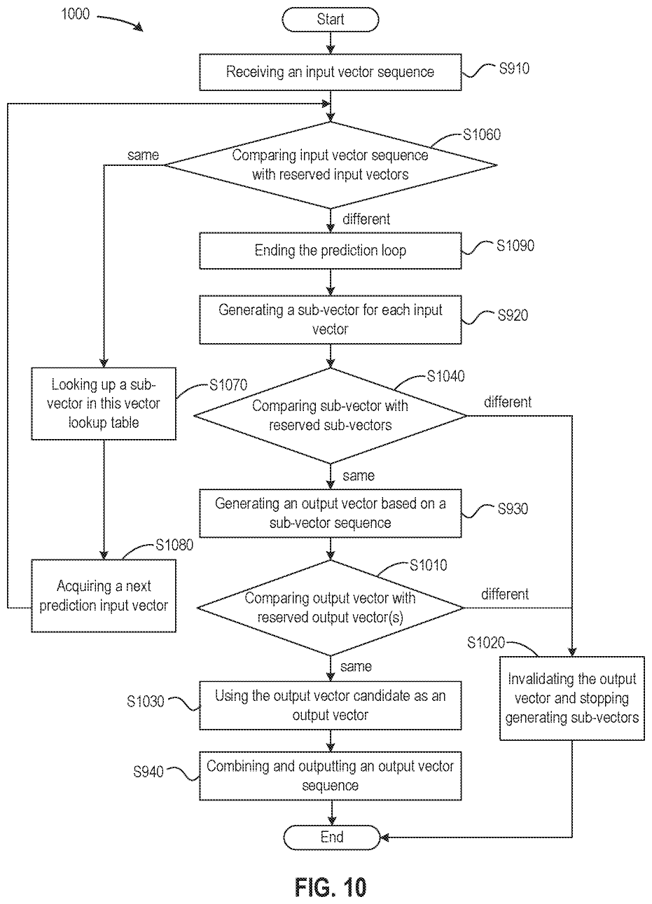

FIG. 10 shows a block diagram of a method 1000 according to some embodiments of the present disclosure. It is appreciated that method 1000 shown in FIG. 10 may be a further extension of method 900 shown in FIG. 9. The same or corresponding reference numbers or blocks are used to indicate the same or corresponding steps.

In some embodiments, one or more steps of method 1000 shown in FIG. 10 that are additional to method 900 of FIG. 9 include some steps related to controlling the processing of step S920 and step S930 according to the content in vector table 520 shown in FIG. 5, respectively. Accordingly, method 1000 can be used for an inhibition function in an inference mode scenario, or a prediction function for speeding up sub-vector generation processing.

According to some embodiments, in order to implement the inhibition function, one or more (e.g., sometimes multiple) reserved output vectors can be stored in vector table 520. In some embodiments, as shown in FIG. 10, method 1000 further includes a step S1010 after step S930. In S1010, the output vector candidate generated in step S930 may be compared with the one or more reserved output vectors. In some embodiments, when the generated output vector candidate is different from any one of the reserved output vectors, the output probability candidate may be invalidated in step S1020. For example, no output vector may be output. In another example, the output vector may be output as a vector of all zeros. Further, the sub-vector generation processing in step S920 may be instructed to stop. In some embodiments, when it is determined in step S1010 that the generated output vector candidate is included in the reserved output vectors, this output vector candidate may be used as an output vector in step S1030. Further, the processing of step S920 may be instructed to continue. In some embodiments, vector table 520 may be used to describe predetermined categories of output probabilities that can be output. That is, performing method 1000 may output one or more reserved output vectors only. Accordingly, when method 1000 is used in an inference mode, only one or more predetermined inference results may be generated.

According to some embodiments, for implementing the inhibition function, vector table 520 may store reserved output vector(s), and a plurality of reserved sub-vectors corresponding to the reserved output vectors. In some embodiments, each reserved sub-vector may correspond to a specific sequence position. In some embodiments, when the input vector sequence is a time-dependent sequence, each reserved sub-vector may correspond to a specific timestamp position. For example, vector table 520 may have the structure shown above with reference to Table 1.

In some embodiments, method 1000 includes step S1040. For example, after generating a sub-vector (also called a sub-vector candidate) in step S920, according to a sequence position corresponding to this sub-vector, the sub-vector may be compared with a reserved sub-vector at an associated position stored in vector table 520. In some embodiments, when this sub-vector candidate is different from any one of the reserved sub-vectors, it may be instructed in step S1020 that the sub-vector generation processing in step S920 is no longer performed. Further, the output vector may be invalidated, for example, the output vector is not output, or the output vector is a vector of all zeros. In some embodiments, when this sub-vector is the same as one reserved sub-vector, the processing of step S920 may be continued to step S930. Accordingly, step S920 may only generate predetermined sub-vectors. As a result, step S930 of method 10000 may only generate predetermined output vectors. In some embodiments, the system and method as described herein may be applied to an inference mode with a finer granularity.

According to some embodiments, in order to realize the function of a prediction function, in addition to storing the above-mentioned reserved output vectors and multiple reserved sub-vectors corresponding to the reserved output vectors, vector table 520 may further store a next input vector corresponding to each sub-vector. In some embodiments as described above, method 1000 may include generating a sub-vector for each input vector of the input vector sequence and then generating an output vector based on a sub-vector sequence. In some embodiments, because there is a successive association among input vectors, the sub-vector sequence is likely to be the same for the same output vectors. Accordingly, after a sub-vector is generated according to a current vector, the content of a next input vector can be expected.

In some embodiments, vector table 520 may have the structure shown above with reference to Table 2.

In some embodiments, when a prediction function is applied, when receiving an input vector with a certain timestamp in step S910, before performing step S920, method 1000 includes step S1060, where vector table 520 may be first checked to identify a reserved input vector with a timestamp position (for example, an immediately earlier timestamp) associated with this timestamp of the received input vector. In step S1060, the received input vector may be compared with the identified reserved input vector. In some embodiments, when the two are the same, a prediction loop can be activated. For example, in the prediction loop, in step S1070, the sub-vector generation processing (e.g., step S920) may not be performed. Instead, a sub-vector with a same timestamp as the timestamp of the received input vector may be identified in vector table 520 to serve as a sub-vector to be output. In step S1080, a value of a next input vector with the same timestamp of the received input vector may be further obtained, and the value of this next input vector may be compared with a next input vector in an input vector sequence to be processed in step S920. When the two are consistent, the processing of the prediction loop may be continued. When the two are not consistent, the prediction loop is ended in step S1090, and step S920 may be caused to perform the normal sub-vector generation processing. A warning that the input vector violates the expected input vector may be triggered.

In method 1000, vector table 520 may store the relationship between output vectors calculated according to method 1000 and sub-vectors and the input vectors. When vector table 520 has a large size, it may store most of the input vectors and sub-vectors that can be processed using method 1000. As such, when the function of a prediction function is activated, the computing needs for performing step S920 can be significantly reduced. In some embodiments, when the function of an inhibition function is activated, results of various prediction branches (corresponding to certain predetermined output vectors) required by an inference scenario may be completely obtained.

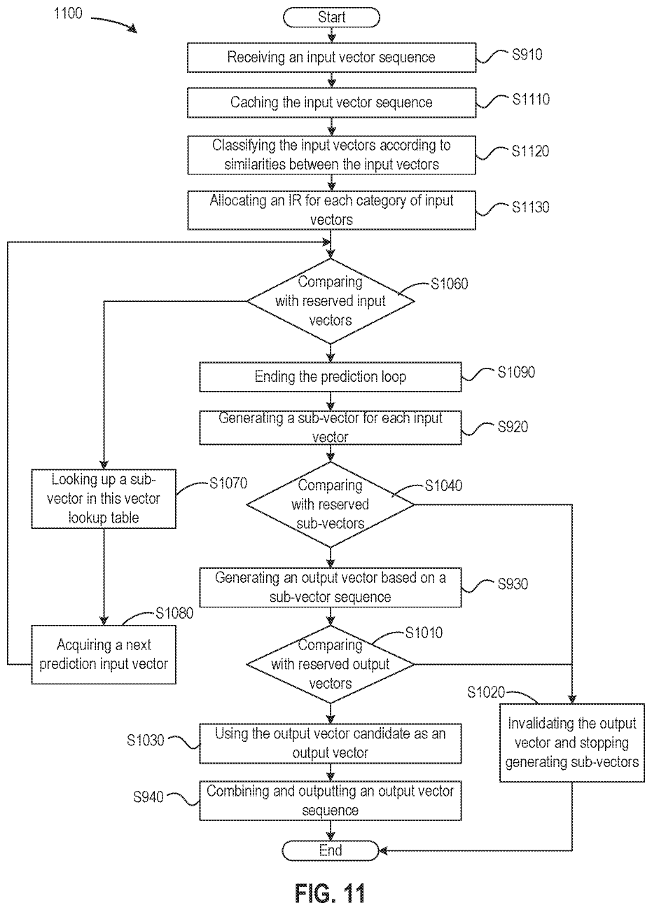

FIG. 11 shows a block diagram of a method 1100 according to some embodiments of the present disclosure. It is appreciated that method 1100 shown in FIG. 11 may be a further extension of method 900 shown in FIG. 9 or unit 1000 shown in FIG. 10. The same or corresponding reference numbers or blocks are used to indicate the same or corresponding components.

In some embodiments, one or more steps of method 1100 as shown in FIG. 11 may be additional to method 900 of FIG. 9 or method 1000 of FIG. 10. For example, in step S1110, one or more input vectors in an input vector sequence may be cached in order. According to some embodiments, the received input vector sequence may be stored in short-term memory (STM) 610. STM 610 may cache multiple input vectors of the input vector sequence. In some embodiments, the cached input vector sequence may be cleared from STM 610 after a period of time or after the processing of the input vector sequence is completed.

In some embodiments, in step S1120, the cached input vectors may be classified. According to some embodiments, in step S1120, similarities between all the cached input vectors may be calculated, and similar input vectors may be classified into one category. There may have various methods for calculating the similarities between the input vectors. For example, similarities between the input vectors can be calculated using Hamming distance, overlap similarity, Euclidean distance, Pearson similarity, cosine similarity, and Jaccard similarity, etc.

In some embodiments, in step S1130, pre-stored invariant representations may be allocated to the categories of input vectors calculated in step S1120 respectively, for example, one pre-stored invariant representation for each category. In some embodiments, an invariant representation may be a vector of the same size as that of the corresponding input vector.

In some embodiments, with the processing of steps S1110 to S1130 of method 1100, the same invariant representation can be allocated to the same or similar input vectors in each input sequence. As such, in subsequent steps S920 and S930, invariant representations can be directly used instead of processing input vectors. Accordingly, method 1100 can be more focused on the structure and repetitive pattern of an input sequence.

The computing methods described above with reference to FIGS. 9-11 can be implemented in an independent computing unit or in the processing core of the processor described above with reference to FIGS. 7 and 8, thereby allowing the processor to implement complex and modular neuromorphic computation.

The computing units described above with reference to FIGS. 1-6 and the processing cores of FIGS. 7-8 in which the methods described with reference to FIGS. 9-11 are implemented can be applied to various fields.

In some embodiments, because the computing unit and the processing core can efficiently process time-sequence-based data, they can be applied to scenarios with time-sequence data, such as video surveillance, monitoring of changes to a GPS trajectory over time, machine translation and oral interpretation, or other scenarios.

In some embodiments, when the functions of prediction or inhibition are activated in the computing unit or the processing core, because a series of predefined output vectors are recorded in the vector table, they can be applied to various inference scenarios, such as unmanned driving, trajectory prediction, or traffic control.

In some embodiments, when the function of prediction is activated in the computing unit or the processing core, since a series of predefined input vector predictions are recorded in the vector table, it is easy to find a situation that is consistent with a prediction result, and then trigger an exception. Accordingly, they can be applied to exception monitoring scenarios, such as traffic control or security monitoring in the urban brain.

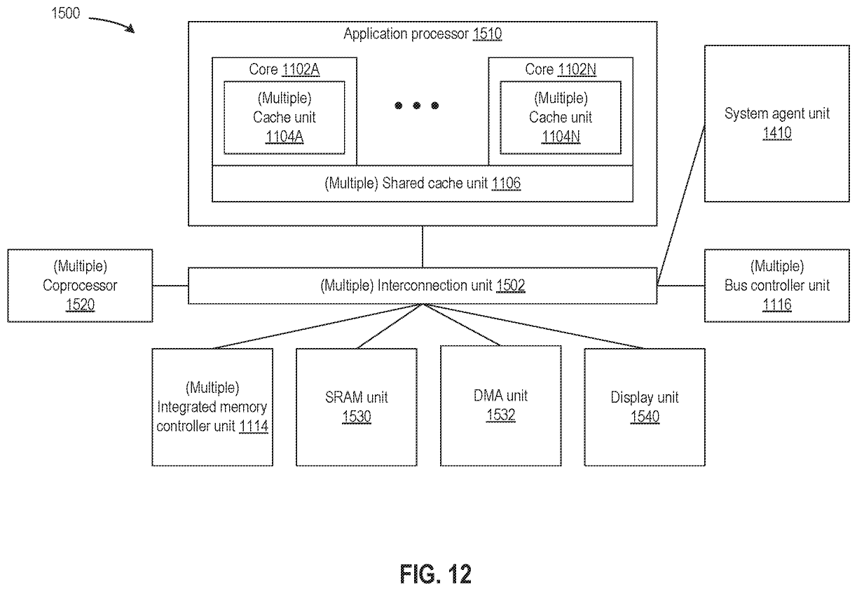

In some embodiments, the processors described above with reference to FIGS. 7 and 8 may be included in a system-on-chip. FIG. 12 shows a schematic diagram of system-on-chip 1500 according to an embodiment of the present disclosure. System-on-chip 1500 shown in FIG. 12 may include processors 700 and 800 shown in FIG. 7 and FIG. 8. Components similar to those in FIG. 7 or 8 use the same reference numbers. As shown in FIG. 12, interconnection unit 1502 can be coupled to application processor 1510, system agent unit 1410, bus controller unit 1116, integrated memory controller unit 1114, one or more coprocessors 1520, static random access memory (SRAM) unit 1530, direct memory access (DMA) unit 1532, and display unit 1540 which may be coupled to one or more external displays. In some embodiments, coprocessors 1520 may include integrated graphics logic, an image processor, an audio processor, and a video processor. In some embodiments, coprocessors 1520 may include a dedicated processor, such as a network or a communication processor, a compression engine, a GPGPU, a high-throughput MIC processor, an embedded processor, and so on.

In some embodiments, the system-on-chip described above may be included in a smart device so as to implement corresponding functions in the smart device, including but not limited to the execution of related control programs, data analysis, calculation and processing, network communication, or control over peripheral devices in the smart device, etc.

In some embodiments, such smart devices may include specialized smart devices, such as mobile terminals or personal digital terminals. These devices may include one or more system-on-chips according to the present disclosure to perform data processing or control peripheral devices in devices.

In some embodiments, such smart devices may also include specialized devices constructed to achieve specific functions, such as smart speakers or smart display devices. These devices may include a system-on-chip according to the present disclosure to control a speaker or a display device, thereby giving the speaker or the display device additional functions such as communication, perception, or data processing.

In some embodiments, such smart devices may also include various Internet of Things (IoT) and Artificial Intelligence of Things (AIoT) devices. These devices may include a system-on-chip according to the present disclosure for data processing, such as Artificial Intelligence (AI) operations, or data communication and transmission, thereby achieving a denser and smarter device distribution.

In some embodiments, such smart devices can also be used in vehicles. For example, they can be implemented as in-vehicle devices, or they can be embedded in vehicles to provide data processing capabilities for intelligent or autonomous driving of vehicles.

In some embodiments, such smart devices can also be used in the home and entertainment fields. For example, they can be implemented as smart speakers, smart air conditioners, smart refrigerators, or smart display devices, and so on. These devices include a system-on-chip according to the present disclosure for data processing and peripheral device control, thereby realizing intelligentization of home and entertainment devices.

In some embodiments, such smart devices can also be used in industrial fields. For example, they can be implemented as industrial control devices, sensing devices, IoT devices, AIoT devices, or braking devices. These devices include a system-on-chip according to the present disclosure for data processing and peripheral device control, thereby realizing intelligentization of industrial equipment.

The above description of the smart device may be only schematic, the smart device according to the present disclosure may not be limited thereto. Any smart devices that can perform data processing using the system-on-chip according to the present disclosure are within the scope of the present disclosure.

Embodiments of the mechanism disclosed herein may be implemented in hardware, software, firmware, or a combination of these implementation methods. Embodiments of the present disclosure may be implemented as a computer program or program code executed on a programmable system that includes at least one processor, a storage system (including volatile and non-volatile memory and/or storage elements), at least one input device, and at least one output device. The embodiments may further be described using the following clauses:

1. A method for processing an input vector sequence to generate an output vector, comprising:

processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and

after sequentially generating the one or more corresponding sub-vectors for the one or more input vectors in the input vector sequence to form a sub-vector sequence including the one or more sub-vectors, generating the output vector based on the sub-vector sequence.

2. The method of clause 1, wherein generating the corresponding sub-vector includes:

using a recurrent neural network to process the one or more adjacent input vectors to obtain a current output vector of the recurrent neural network;

determining a vector difference between the current output vector and a previous output vector of the recurrent neural network; and

performing compression processing to the vector difference to generate the sub-vector.

3. The method of clause 2, wherein determining the vector difference between the current output vector and the previous output vector includes:

performing an XOR operation on the current output vector and the previous output vector of the recurrent neural network to generate the vector difference.

4. The method of any of clauses 1-3, wherein performing compression processing to the vector difference includes:

dividing the vector difference into a predetermined number of compression windows, each compression window occupying a predetermined number of bits of the vector difference;

for each compression window, allocating a value of 1 or 0 to the compression window according to a predetermined position value of the vector difference in the compression window; and

constructing the sub-vector by combining the values allocated to all the compression windows.

5. The method of any of clauses 1-4, wherein generating the output vector includes: performing a bit-level logic operation on all the sub-vectors in the sub-vector sequence to generate the output vector.

6. The method of clause 5, wherein the bit-level logic operation includes one of the following bit-level logic operations:

XOR or XNOR.

7. The method of method of any of clauses 1-6, further comprising:

controlling the processing of generating the one or more sub-vectors and the processing of generating the output vector according to a vector table.

9. The method of clause 7, wherein the vector table stores one or more reserved output vectors, and

wherein controlling the processing of generating the one or more sub-vectors and the processing of generating the output vector further comprises:

in accordance with determining that the generated output vector is different from any one of the one or more reserved output vectors, forgoing generating the sub-vector, and invalidating the generated output vector.

9. The method of clause 7, wherein the vector table stores reserved output vectors and a sub-vector sequence associated with the reserved output vectors, and wherein controlling the processing of generating the one or more sub-vectors and the processing of generating the output vector further comprises:

determining in the vector table a reserved output vector corresponding to the generated sub-vector according to a position of the generated sub-vector in the generated sub-vector sequence; and

in accordance with determining that the generated sub-vector is different from a sub-vector at an associated position of the sub-vector sequence associated with the reserved output vectors, foregoing generating the sub-vector, and invalidating the generated output vector.

10. The method of clause 9, wherein invalidating the generated output vector includes foregoing outputting the output vector.

11. The method of clause 7, wherein the vector table stores reserved output vectors, a sub-vector sequence associated with the reserved output vectors, and a next input vector corresponding to each sub-vector in the sub-vector sequence, and wherein controlling the processing of generating the one or more sub-vectors and the processing of generating the output vector further comprises:

looking up, in the vector table, a reserved output vector corresponding to the input vector according to a position of the input vector in the input vector sequence;

in accordance with determining that the reserved output vector is found, foregoing generating the sub-vector, and using a sub-vector at an associated position of a sub-vector sequence associated with the found reserved output vector as the generated sub-vector;

acquiring a next input vector corresponding to the sub-vector from the vector table; and

in accordance with determining that the acquired next input vector is the same as a next input vector in the input vector sequence, continuing to forego generating the sub-vector, and using the sub-vector at the next position of the sub-vector sequence as the generated sub-vector.

12. The method of clause 11, wherein controlling the processing of generating the one or more sub-vectors and the processing of generating the output vector further comprises:

in accordance with determining that the acquired next input vector is different from the next input vector in the input vector sequence, performing the processing of probability generation, or performing exception processing.

13. The method of any of clauses 1-12, further comprising:

receiving the input vector sequence, and caching all input vectors of the input vector sequence in order.

14. The method of clause 13, further comprising:

classifying the cached input vectors according to similarities between the input vectors;

determining a corresponding invariant representation for each category of input vectors, the invariant representation being a vector of the same size as the input vector; and

replacing the input vector with the invariant representation corresponding to the input vector in processing the one or more input vectors of the input vector sequence to generate one or more sub-vectors respectively, generating the output vector, and controlling the processing generating the one or more sub-vectors and the processing of generating the output vector.

15. A computing device configured to processing an input vector sequence to generate an output vector, comprising:

one or more processors; and

memory coupled to the one or more processors and storing instructions that, when executed by the computing device, cause the computing device to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

16. The computing device of clause 15, wherein the memory further stores instructions that, when executed by the computing device, cause the computing device to perform:

using a recurrent neural network to process the one or more adjacent input vectors to obtain a current output vector of the recurrent neural network;

determining a vector difference between the current output vector and a previous output vector of the recurrent neural network; and

performing compression processing to the vector difference to generate the sub-vector.

17. The computing device of clause 16, wherein the vector difference is determined by performing an XOR operation on the current output vector and a previous output vector of the recurrent neural network to generate the vector difference.

18. The computing device of any of clauses 15-17, wherein the vector difference is determined by:

dividing the vector difference into a predetermined number of compression windows, each compression window occupying a predetermined number of bits of the vector difference;

for each compression window, allocating a value of 1 or 0 to the compression window according to a predetermined position value of the vector difference in the compression window; and

constructing the sub-vector by combining the values allocated to all the compression windows.

19. The computing device of any of clauses 15-18, wherein the output vector is generated performing a bit-level logic operation on all the sub-vectors in the sub-vector sequence to generate the output vector.

20. The computing device of clause 19, wherein the bit-level logic operation includes one of the following bit-level logic operations:

XOR or XNOR.

21. The computing device of any of clauses 15-20, further including a memory for storing a vector table, and wherein the memory further stores instructions that, when executed by the computing device, cause the computing device to perform:

generating the output vector according to content of the vector table.

22. The computing device of clause 21, wherein the vector table stores one or more reserved output vectors, and in accordance with determining that the generated output vector is different from any one of the one or more reserved output vectors, the memory further stores instructions that, when executed by the computing device, cause the computing device to perform:

foregoing generating the sub-vector; and

invalidating the generated output vector.

23. The computing device of clause 21, wherein the vector table further stores reserved output vectors and a sub-vector sequence associated with the reserved output vectors, the memory further stores instructions that, when executed by the computing device, cause the computing device to perform:

determining in the vector table a reserved sub-vector corresponding to the generated sub-vector according to a position of the generated sub-vector in the generated sub-vector sequence; and

in accordance with determining that the generated sub-vector is different from a sub-vector at an associated position of the sub-vector sequence associated with the reserved output vectors, foregoing generating the sub-vector, and invalidating the generated output vector.

24. The computing device of clause 23, wherein invalidating the generated output vector includes foregoing outputting the output vector.

25. The computing device of clause 21, wherein the vector table further stores reserved output vectors, a sub-vector sequence associated with the reserved output vectors, and a next input vector corresponding to each sub-vector in the sub-vector sequence, and wherein the memory further stores instructions that, when executed by the computing device, cause the computing device to perform:

looking up, in the vector table, a reserved input vector sequence according to the position of the input vector in the input vector sequence;

in accordance with determining that a reserved input vector which is the same as the input vector is found, foregoing generating the sub-vector, and using a sub-vector at an associated position of a sub-vector sequence associated with the found reserved input vector as the generated sub-vector;

acquiring a next input vector corresponding to the sub-vector from the vector table;

in accordance with determining that the acquired next input vector is the same as a next input vector in the input vector sequence, continuing to forego generating the sub-vector; and

using the sub-vector at the next position of the sub-vector sequence as the generated sub-vector.

26. The computing device of clause 25, wherein the memory further stores instructions that, when executed by the computing device, cause the computing device to perform:

in accordance with determining that the acquired next input vector is different from the next input vector in the input vector sequence, instructing the sub-vector generator to perform the processing of sub-probability generation or perform exception processing.

27. The computing device of any of clauses 15-26, wherein the memory further stores instructions that, when executed by the computing device, cause the computing device to perform:

receiving the input vector sequence; and

caching all input vectors of the input vector sequence in order.

28. The computing device of clause 27, wherein the memory further stores instructions that, when executed by the computing device, cause the computing device to perform:

classifying the input vectors cached in the short-term memory according to similarities between the input vectors;

determining a corresponding invariant representation for each category of input vectors, the invariant representation being a vector of the same size as the input vector; and

replacing the input vector with the invariant representation corresponding to the input vector to perform the sub-vector generation processing and the output vector generation processing.

29. A processor configured to process an input vector sequence to generate an output vector, the processor including one or more processing cores, wherein each processing core is configured to execute instructions stored on memory to perform:

processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and

after sequentially generating the one or more corresponding sub-vectors for the one or more input vectors in the input vector sequence to form a sub-vector sequence including the one or more sub-vectors, generating the output vector based on the sub-vector sequence.

30. The processor of clause 29, the one or more processing cores including a first processing core and a second processing core coupled to the first processing core, wherein

the first processing core receives the input vector sequence and generates an intermediate output vector; and

the second processing core receives the intermediate output vector generated by the first processing core and processes it as an input vector of the second processing core to generate and output the output vector.

31. A system-on-chip including a processor configured to process an input vector sequence to generate an output vector, the processor including one or more processing cores, wherein each processing core is configured to execute instructions stored on memory to perform:

processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and

after sequentially generating the one or more corresponding sub-vectors for the one or more input vectors in the input vector sequence to form a sub-vector sequence including the one or more sub-vectors, generating the output vector based on the sub-vector sequence.

32. The system-on-chip of clause 31, the one or more processing cores including a first processing core and a second processing core coupled to the first processing core, wherein

the first processing core receives the input vector sequence and generates an intermediate output vector; and

the second processing core receives the intermediate output vector generated by the first processing core and processes it as an input vector of the second processing core to generate and output the output vector.

33. A smart device configured to process an input vector sequence to generate an output vector, the smart device comprising:

one or more processors; and

memory coupled to the one or more processors and storing instructions that, when executed by the computing device, cause the computing device to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

34. A non-transitory computer-readable medium storing program instructions, that when read and executed by a processor, cause the processor to perform:

processing one or more input vectors of an input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and

after sequentially generating the one or more corresponding sub-vectors for the one or more input vectors in the input vector sequence to form a sub-vector sequence including the one or more sub-vectors, generating an output vector based on the sub-vector sequence.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It should be understood that in order to simplify the present disclosure and help understand one or more of the various inventive aspects, in the above description of example embodiments of the present disclosure, various features of the present disclosure are sometimes grouped together into a single embodiment, drawing, or description thereof. However, the disclosed method should not be interpreted as reflecting the intention that the claimed disclosure claims more features than those explicitly recited in each claim. More specifically, as reflected by the following claims, inventive aspects can lie in fewer than all features of a single foregoing disclosed embodiment. Therefore, the claims that follow a specific implementation are hereby expressly incorporated into the specific implementation, where each claim itself serves as a separate embodiment of the present disclosure.

Those skilled in the art should understand that the modules or units or components of the device in the examples disclosed herein may be arranged in the device as described in this embodiment, or alternatively may be positioned in one or more devices different from the device in this example. The modules in the foregoing examples may be combined into one module or, in addition, may be divided into multiple sub-modules.

Those skilled in the art can understand that the modules in the device in the embodiment can be adaptively changed and set in one or more devices different from this embodiment. The modules or units or components in the embodiment may be combined into one module or unit or component, and in addition, they may be divided into a plurality of submodules or subunits or subcomponents. Except that at least some of such features and/or processes or units are mutually exclusive, all features disclosed in this specification (including the accompanying claims, abstract, and drawings) and any method so disclosed or all processes or units of the device can be combined in any combination. Unless expressly stated otherwise, each feature disclosed in this specification (including the accompanying claims, abstract, and drawings) may be replaced with an alternative feature providing the same, equivalent, or similar purpose.

Furthermore, those skilled in the art can understand that although some of the embodiments described herein include certain features included in other embodiments but not other features, the combination of features of different embodiments is meant to be within the scope of the present disclosure and form different embodiments. For example, in the following claims, any of the claimed embodiments can be used in any combination.

Furthermore, some of the described embodiments are described herein as methods or combinations of method elements that can be implemented by a processor of a computer system or by other means that perform the described functions. Therefore, a processor having the necessary instructions for implementing the method or method element forms a means for implementing the method or method element. Furthermore, the element of the apparatus embodiment described herein is an example of the following apparatus for implementing the function performed by the element for the purpose of implementing the present disclosure.

As used herein, unless otherwise specified, the use of the ordinal words “first,” “second,” “third,” etc. to describe ordinary objects merely indicates different instances involving similar objects and is not intended to imply that the objects so described must have a given order in time, in space, in order, or in any other way.

Although the present disclosure has been described in terms of a limited number of embodiments, benefiting from the above description, those skilled in the art understand that other embodiments are conceivable within the scope of the present disclosure thus described. Furthermore, it should be noted that the language used in this specification is mainly selected for readability and teaching purposes, not for explaining or limiting the subject matter of the present disclosure. Therefore, many modifications and variations will be apparent to those of ordinary skill in the art without departing from the scope and spirit of the appended claims. With regard to the scope of the present disclosure, the disclosure made to the present disclosure is illustrative rather than limiting, and the scope of the present disclosure is defined by the appended claims.

1. A method for processing an input vector sequence to generate an output vector, comprising:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

2. The method of claim 1, wherein generating the corresponding sub-vector includes:
using a recurrent neural network to process the one or more adjacent input vectors to obtain a current output vector of the recurrent neural network;
determining a vector difference between the current output vector and a previous output vector of the recurrent neural network; and
performing compression processing to the vector difference to generate the sub-vector.

3. The method of claim 2, wherein determining the vector difference between the current output vector and the previous output vector includes:
performing an XOR operation on the current output vector and the previous output vector of the recurrent neural network to generate the vector difference.

4. The method of claim 3, wherein performing compression processing to the vector difference includes:
dividing the vector difference into a predetermined number of compression windows, each compression window occupying a predetermined number of bits of the vector difference;
for each compression window, allocating a value of 1 or 0 to the compression window according to a predetermined position value of the vector difference in the compression window; and
constructing the sub-vector by combining the values allocated to all the compression windows.

5. The method of claim 1, wherein generating the output vector includes:
performing a bit-level logic operation on all the sub-vectors in the sub-vector sequence to generate the output vector.

6. The method of claim 5, wherein the bit-level logic operation includes one of the following bit-level logic operations:
XOR or XNOR.

7. The method of claim 1, further comprising:
controlling the processing of generating the one or more sub-vectors and the processing of generating the output vector according to a vector table.

8. The method of claim 7, wherein the vector table stores one or more reserved output vectors, and
wherein controlling the processing of generating the one or more sub-vectors and the processing of generating the output vector further comprises:
in accordance with determining that the generated output vector is different from any one of the one or more reserved output vectors, forgoing generating the sub-vector, and invalidating the generated output vector.

9. The method of claim 7, wherein the vector table stores reserved output vectors and a sub-vector sequence associated with the reserved output vectors, and wherein controlling the processing of generating the one or more sub-vectors and the processing of generating the output vector further comprises:
determining in the vector table a reserved output vector corresponding to the generated sub-vector according to a position of the generated sub-vector in the generated sub-vector sequence; and
in accordance with determining that the generated sub-vector is different from a sub-vector at an associated position of the sub-vector sequence associated with the reserved output vectors, foregoing generating the sub-vector, and invalidating the generated output vector.

10. The method of claim 9, wherein invalidating the generated output vector includes foregoing outputting the output vector.

11. The method of claim 7, wherein the vector table stores reserved output vectors, a sub-vector sequence associated with the reserved output vectors, and a next input vector corresponding to each sub-vector in the sub-vector sequence, and wherein controlling the processing of generating the one or more sub-vectors and the processing of generating the output vector further comprises:
looking up, in the vector table, a reserved output vector corresponding to the input vector according to a position of the input vector in the input vector sequence;
in accordance with determining that the reserved output vector is found, foregoing generating the sub-vector, and using a sub-vector at an associated position of a sub-vector sequence associated with the found reserved output vector as the generated sub-vector;
acquiring a next input vector corresponding to the sub-vector from the vector table; and
in accordance with determining that the acquired next input vector is the same as a next input vector in the input vector sequence, continuing to forego generating the sub-vector, and using the sub-vector at the next position of the sub-vector sequence as the generated sub-vector.

12. The method of claim 11, wherein controlling the processing of generating the one or more sub-vectors and the processing of generating the output vector further comprises:
in accordance with determining that the acquired next input vector is different from the next input vector in the input vector sequence, performing the processing of probability generation, or performing exception processing.

13. The method of claim 1, further comprising:
receiving the input vector sequence, and caching all input vectors of the input vector sequence in order.

14. The method of claim 13, further comprising:
classifying the cached input vectors according to similarities between the input vectors;
determining a corresponding invariant representation for each category of input vectors, the invariant representation being a vector of the same size as the input vector; and
replacing the input vector with the invariant representation corresponding to the input vector in processing the one or more input vectors of the input vector sequence to generate one or more sub-vectors respectively, generating the output vector, and controlling the processing generating the one or more sub-vectors and the processing of generating the output vector.

15. A computing device configured to processing an input vector sequence to generate an output vector, comprising:
one or more processors; and
memory coupled to the one or more processors and storing instructions that, when executed by the computing device, cause the computing device to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

16. The computing device of claim 15, wherein the memory further stores instructions that, when executed by the computing device, cause the computing device to perform:
using a recurrent neural network to process the one or more adjacent input vectors to obtain a current output vector of the recurrent neural network;
determining a vector difference between the current output vector and a previous output vector of the recurrent neural network; and
performing compression processing to the vector difference to generate the sub-vector.

17. The computing device of claim 16, wherein the vector difference is determined by performing an XOR operation on the current output vector and a previous output vector of the recurrent neural network to generate the vector difference.

18. The computing device of claim 17, wherein vector difference is determined by:
dividing the vector difference into a predetermined number of compression windows, each compression window occupying a predetermined number of bits of the vector difference;
for each compression window, allocating a value of 1 or 0 to the compression window according to a predetermined position value of the vector difference in the compression window; and
constructing the sub-vector by combining the values allocated to all the compression windows.

19. The computing device of claim 13, wherein the output vector is generated performing a bit-level logic operation on all the sub-vectors in the sub-vector sequence to generate the output vector.

20. The computing device of claim 19, wherein the bit-level logic operation includes one of the following bit-level logic operations:
XOR or XNOR.

21. The computing device of claim 14, further including a memory for storing a vector table, and wherein the memory further stores instructions that, when executed by the computing device, cause the computing device to perform:
generating the output vector according to content of the vector table.

22. The computing device of claim 21, wherein the vector table stores one or more reserved output vectors, and in accordance with determining that the generated output vector is different from any one of the one or more reserved output vectors, the memory further stores instructions that, when executed by the computing device, cause the computing device to perform:
foregoing generating the sub-vector; and
invalidating the generated output vector.

23. The computing device of claim 21, wherein the vector table further stores reserved output vectors and a sub-vector sequence associated with the reserved output vectors, the memory further stores instructions that, when executed by the computing device, cause the computing device to perform:
determining in the vector table a reserved sub-vector corresponding to the generated sub-vector according to a position of the generated sub-vector in the generated sub-vector sequence; and
in accordance with determining that the generated sub-vector is different from a sub-vector at an associated position of the sub-vector sequence associated with the reserved output vectors, foregoing generating the sub-vector, and invalidating the generated output vector.

24. The computing device of claim 23, wherein invalidating the generated output vector includes foregoing outputting the output vector.

25. The computing device of claim 21, wherein the vector table further stores reserved output vectors, a sub-vector sequence associated with the reserved output vectors, and a next input vector corresponding to each sub-vector in the sub-vector sequence, and wherein the memory further stores instructions that, when executed by the computing device, cause the computing device to perform:
looking up, in the vector table, a reserved input vector sequence according to the position of the input vector in the input vector sequence;
in accordance with determining that a reserved input vector which is the same as the input vector is found, foregoing generating the sub-vector, and using a sub-vector at an associated position of a sub-vector sequence associated with the found reserved input vector as the generated sub-vector;
acquiring a next input vector corresponding to the sub-vector from the vector table; and
in accordance with determining that the acquired next input vector is the same as a next input vector in the input vector sequence, continuing to forego generating the sub-vector;
using the sub-vector at the next position of the sub-vector sequence as the generated sub-vector.

26. The computing device of claim 25, wherein the memory further stores instructions that, when executed by the computing device, cause the computing device to perform:
in accordance with determining that the acquired next input vector is different from the next input vector in the input vector sequence, instructing the sub-vector generator to perform the processing of sub-probability generation or perform exception processing.

27. The computing device of claim 15, wherein the memory further stores instructions that, when executed by the computing device, cause the computing device to perform:
receiving the input vector sequence; and
caching all input vectors of the input vector sequence in order.

28. The computing device of claim 27, wherein the memory further stores instructions that, when executed by the computing device, cause the computing device to perform:
classifying the input vectors cached in the short-term memory according to similarities between the input vectors;
determining a corresponding invariant representation for each category of input vectors, the invariant representation being a vector of the same size as the input vector; and
replacing the input vector with the invariant representation corresponding to the input vector to perform the sub-vector generation processing and the output vector generation processing.

29. A processor configured to process an input vector sequence to generate an output vector, the processor including one or more processing cores, wherein each processing core is configured to execute instructions stored on memory to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

30. The processor of claim 29, the one or more processing cores including a first processing core and a second processing core coupled to the first processing core, wherein
the first processing core receives the input vector sequence and generates an intermediate output vector; and
the second processing core receives the intermediate output vector generated by the first processing core and processes it as an input vector of the second processing core to generate and output the output vector.

31. A system-on-chip including a processor configured to process an input vector sequence to generate an output vector, the processor including one or more processing cores, wherein each processing core is configured to execute instructions stored on memory to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

32. The system-on-chip of claim 31, the one or more processing cores including a first processing core and a second processing core coupled to the first processing core, wherein
the first processing core receives the input vector sequence and generates an intermediate output vector; and
the second processing core receives the intermediate output vector generated by the first processing core and processes it as an input vector of the second processing core to generate and output the output vector.

33. A smart device configured to process an input vector sequence to generate an output vector, the smart device comprising:
one or more processors; and
memory coupled to the one or more processors and storing instructions that, when executed by the computing device, cause the computing device to perform:
processing one or more input vectors of the input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating the output vector based on the sub-vector sequence.

34. A non-transitory computer-readable medium storing program instructions, that when read and executed by a processor, cause the processor to perform:
processing one or more input vectors of an input vector sequence to generate one or more sub-vectors respectively, the input vector sequence including a plurality of input vectors including the one or more input vectors arranged in a sequence, wherein the plurality of input vectors and the output vector characterize features of an object, and wherein a respective input vector is processed by processing one or more input vectors adjacent to the respective input vector in the input vector sequence using a machine learning method to generate a corresponding sub-vector; and
after sequentially generating the one or more corresponding sub-vectors for the one or more input vectors in the input vector sequence to form a sub-vector sequence including the one or more sub-vectors, generating an output vector based on the sub-vector sequence.
